(19) United States
(12) Patent Application Publication
(10) Pub. No.: US 2023/0244204 A1
(43) Pub. Date: Aug. 3, 2023

(54) SIMPLIFIED PLC PROGRAMMING WITH MOBILE DEVICE

(71) Applicant: Hitachi, Ltd., Tokyo (JP)

(72) Inventors: Yi-chu Chang, Farmington Hills, MI (US); Lili Zheng, Novi, MI (US)

(21) Appl. No.: 17/584,075

(22) Filed: Jan. 25, 2022

(51) Int. Cl. G05B 19/05; G06K 7/14; H04L 41/00

(52) U.S. Cl. CPC G05B 19/056; G06K 7/1443; H04L 41/26; G10L 15/22

(57) ABSTRACT

Aspects of the present disclosure can involve systems and methods for a mobile device connected to a local area network (LAN) facilitating connections between a programmable logic controller (PLC) and one or more apparatuses, the mobile device involving a camera and a microphone, which can involve receiving input from one or more of the camera and the microphone; generating one or more of executable code for the PLC and configuration information for the one or more apparatuses from parsing of the input; and transmitting, over the LAN, the one or more of the executable code for the PLC and the configuration information for the one or more apparatuses to the PLC.

### BACKGROUND

### Field

The present disclosure is generally directed to industrial systems, and more specifically, to systems and methods for facilitating programmable logic controller (PLC) programming with a mobile device.

### Related Art

Personal Computers (PCs) and laptops have been used to program and configure industrial devices for a long time, such as PLCs and robots. However, it may not be convenient to do programming with a mouse or keyboard due to the messy on-site situation. In addition, with the development of functionality, such as high-resolution cameras and noise-cancellation microphones, mobile devices have become more than a traditional phone or camera.

Further, suppliers of industrial devices have been trying to simplify the configuration process and utilization methods to benefit end users. In the related art, the users may need to use specific software from each supplier for the initial setup, such as internet protocol (IP) address and Input/Output (I/O) setup. This setup work can take time across many devices. In addition, should the user need to change the configuration in the future, it will be extremely time-consuming to revise all devices on the production line by opening and reviewing all the software.

Related art implementations can involve PLC with programmable touch panel. There can also be web-based functionality for configuration and control of a device in the related art. In such a related art implementation, the user uses a web browser to run a program on a computer workstation. In another related art implementation, there is an application for the user to set up and access a PLC remotely via a Bluetooth device.

### SUMMARY

Traditionally, PLC programming has been done with PC or laptop. Users need to type, select, and click many times just for one program. In addition, it takes time to configure and program equipment and devices. For example, users may need to open complicated programs to do the configuration, such as IP address and Input/Output setup. This work is extremely time-consuming, especially in a large-scale production line. The example implementations described herein simplify PLC programming and device configuration to enhance efficiency. Further, the methods described herein are targeted to mobile devices, such as mobile devices, because user may feel more comfortable bring a lightweight device while walking on the shop floor.

The first issue in the related art is the complicated programming tools. The ladder program, which is one of the PLC programming tools, has been widely used by users. However, users need to select, type, and click many times to complete a program. In the ladder program, the structure is straight forward, so example implementations described herein generate the structure with a speech recognition system. Ladder program involves major keywords, and the programming tool generates corresponding ladders while the user says those keywords. Then, the user can easily edit or revise with the mobile device. With this speech recognition system, users can simplify the procedure of the ladder programming and save time. Also, the user can revise the program anytime and anywhere with a mobile device.

The second issue is equipment configuration. Traditionally, equipment configuration involves the setup of hardware and software. Hardware setup requires manually configuring the equipment itself, and the software setup is done with the PLC program. Such a setup process may be confusing if there are many devices to configure. In example implementations described herein, there is a method such that the system will provide suggestions for the configuration once information for each device is received, such as from scanning for a specific barcode or Quick Response (QR) code on equipment. In this method, the system gives a suggestion so that misuse or errors in configuration may be prevented.

The proposed simplified PLC programming method does not just save time while programming PLC and automation devices, but also facilitates the migration of programming tools to the mobile device so that the user can feel comfortable while doing programming on site.

Example implementations can utilize commonly used hardware without any extra transition media devices. The proposed methods herein has the following advantages that can overcome the issues with traditional PLC programming tools mentioned above.

The first advantage is that the proposed new method provides an alternative option to program the PLC by utilizing built-in functions of mobile devices. Microphones and cameras are common devices in mobile devices. In this method, the user can easily do programming anywhere with lightweight tools instead of bringing a laptop to the production line. As processing power improves, mobile devices may take the place of PC and laptop in more and more areas, including industrial and automation. Therefore, the proposed methods does not just simplify PLC programming, but focuses on development and application of next-generation industrial and automation tools.

The second advantage is to make the process more straight forward while doing the device configuration setup with the camera. Traditionally, it takes time doing the hardware and the software configuration, especially the software configuration as it needs to be verified in the PLC program. However, the proposed methods can display all required information on screen and that can be linked to PLC program directly. Users can easily search and program for each device after doing the configuration. Therefore, the example implementations speed up the entire PLC programming procedure with original built-in functions of common mobile devices.

The third advantage is to reduce the costs of programming tools. With the widespread use of mobile devices, costs of PC/laptop and mobile devices will become closer. In addition, if most required industrial and automation software can be migrated into mobile devices, the user does not need a huge and heavy PC or laptop, but only needs a convenient mobile device for working on the floor and for meeting in the office. Therefore, this method simplifies not just programming software but the hardware setup as well.

In example implementations described herein, the speech recognition system is used to generate the PLC program so that user just needs to provide minimal manipulation instead of another display for traditional programming method with a keyboard and mouse. Compared with the related art, example implementations provide novel methods for programming the PLC ladder.

In example implementations described herein, the device or PLC can still run the program individually but the programming method are novel. The example implementations maintain the same working process of PLC and devices, but provides a simplified programming method in order to secure the system without confusing users. The example implementations can be applied in existing devices instead of brand-new ones. In example implementations described herein, traditional wireless connections can be used to access the PLC via mobile device.

Aspects of the present disclosure can involve a method for a mobile device connected to a local area network (LAN) facilitating connections between a programmable logic controller (PLC) and one or more apparatuses, the mobile device involving a camera and a microphone, the method involving receiving input from one or more of the camera and the microphone; generating one or more of executable code for the PLC and configuration information for the one or more apparatuses from parsing of the input; and transmitting, over the LAN, the one or more of the executable code for the PLC and the configuration information for the one or more apparatuses to the PLC.

Aspects of the present disclosure can involve a computer program, storing instructions for a mobile device connected to a local area network (LAN) facilitating connections between a programmable logic controller (PLC) and one or more apparatuses, the mobile device involving a camera and a microphone, the instructions involving receiving input from one or more of the camera and the microphone; generating one or more of executable code for the PLC and configuration information for the one or more apparatuses from parsing of the input; and transmitting, over the LAN, the one or more of the executable code for the PLC and the configuration information for the one or more apparatuses to the PLC. The computer program and instructions can be stored in a non-transitory computer readable medium and executed by one or more processors.

Aspects of the present disclosure can involve a system for a mobile device connected to a local area network (LAN) facilitating connections between a programmable logic controller (PLC) and one or more apparatuses, the mobile device involving a camera and a microphone, the system involving means for receiving input from one or more of the camera and the microphone; means for generating one or more of executable code for the PLC and configuration information for the one or more apparatuses from parsing of the input; and means for transmitting, over the LAN, the one or more of the executable code for the PLC and the configuration information for the one or more apparatuses to the PLC.

Aspects of the present disclosure can involve a mobile device configured to be connected to a local area network (LAN) facilitating connections between a programmable logic controller (PLC) and one or more apparatuses, the mobile device involving a camera; a microphone; and a processor, configured to receive input from one or more of the camera and the microphone; generate one or more of executable code for the PLC and configuration information for the one or more apparatuses from parsing of the input; and transmit, over the LAN, the one or more of the executable code for the PLC and the configuration information for the one or more apparatuses to the PLC.

### BRIEF DESCRIPTION OF DRAWINGS

FIG. 1 is an overview of traditional architecture of programming PLC and devices.

FIG. 2 is the detail plot of the traditional PLC programming architecture.

FIG. 3 is the workflow of procedure of traditional PLC programming method.

FIG. 4 is an illustration of the new PLC programming technique, including speech recognition (upper) and vision-based device configuration (bottom), in accordance with an example implementation.

FIG. 5 illustrates three cases of automatic PLC ladder generation via the function of speech recognition, in accordance with an example implementation.

FIG. 6 is three examples of using vision-based device configuration and setup with mobile device, in accordance with an example implementation.

FIG. 7 is the workflow of the speech-based automatic PLC ladder generation and the vision-based device configuration methods, in accordance with an example implementation.

FIG. 8 illustrates an example of a mobile device, in accordance with an example implementation.

FIG. 9 illustrates example management information which may be stored on the mobile device to facilitate the example implementations described herein.

### DETAILED DESCRIPTION

The following detailed description provides details of the figures and example implementations of the present application. Reference numerals and descriptions of redundant elements between figures are omitted for clarity. Terms used throughout the description are provided as examples and are not intended to be limiting. For example, the use of the term “automatic” may involve fully automatic or semi-automatic implementations involving user or administrator control over certain aspects of the implementation, depending on the desired implementation of one of ordinary skill in the art practicing implementations of the present application. Selection can be conducted by a user through a user interface or other input means, or can be implemented through a desired algorithm. Example implementations as described herein can be utilized either singularly or in combination and the functionality of the example implementations can be implemented through any means according to the desired implementations.

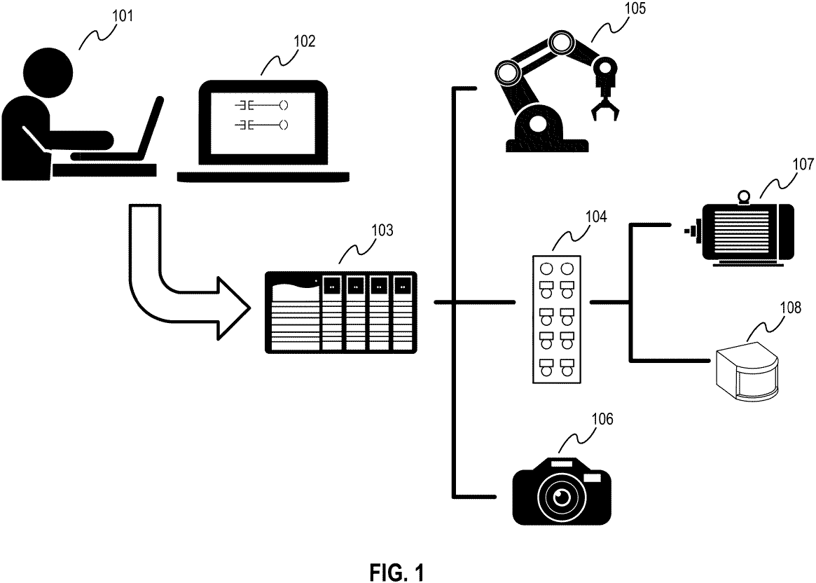

FIG. 1 is an overview of the traditional programming method. A user on a PC 101 works on PLC ladder software 102 and then downloads to a PLC 103, which is connected to an I/O adapter 104, an industrial robot 105, and an industrial camera 106. The I/O adapter 104 is communicated with a motor 107 and a safety scanner 108.

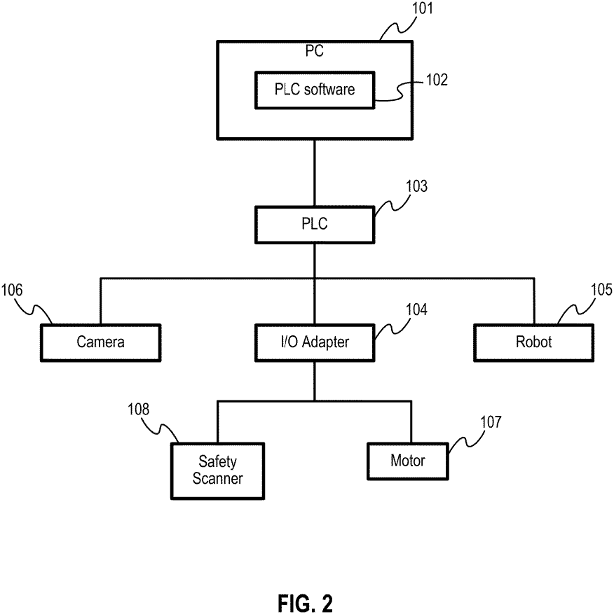

FIG. 2 shows a clear plot of FIG. 1. User operates PC 101 and to do PLC programming software 102, and then downloads the software code to a PLC 103. This PLC is used to communicate with an I/O adapter 104, an industrial robot 105, and an industrial camera 106. The I/O adapter 104 is connected with a motor 107 and a safety scanner 108.

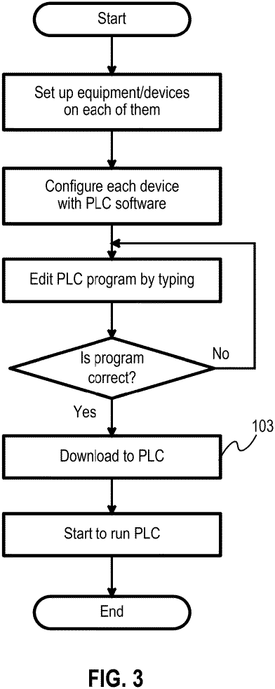

FIG. 3 is the workflow of the traditional PLC programming method. As illustrated in the flow, the user may need to configure each of the devices, including the setup on the device itself and in software. Once the configuration is set up correctly, the user uses a PC for PLC ladder programming.

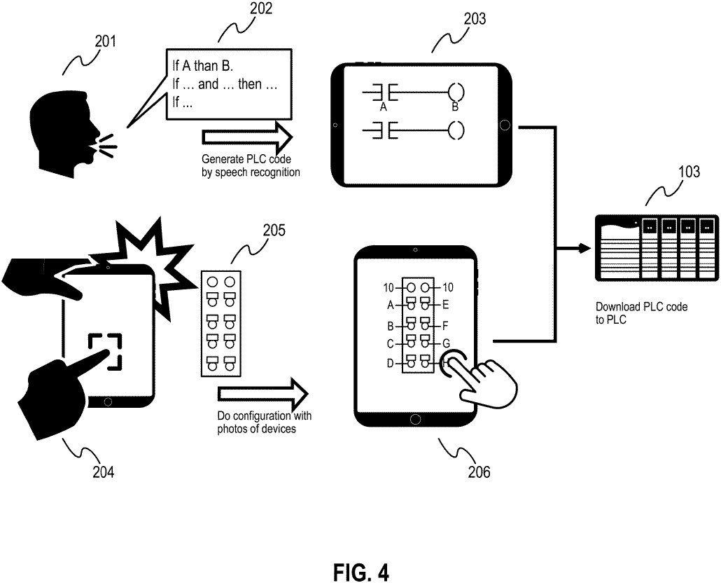

FIG. 4 illustrates the two methods to simplify the traditional PLC programming method, in accordance with an example implementation. It contains a speech-recognition-system-based PLC ladder programming method, and a vision-based device configuration method. The former is to function as speech recognition to generate the PLC ladder automatically on a mobile device. The latter is to confige by taking photos of devices. Both of them utilize peripheral devices of a mobile device, such as built-in microphone and camera. This method provides more convenience for users and simplifies the programming procedure with a lightweight mobile device.

In the example of the speech recognition system, the user 201 provides speech input 202 into the microphone of the mobile device 203. The mobile device 203 is configured to process the speech input with related art speech recognition techniques and generates executable PLC code. The PLC code can then be downloaded to a PLC 103.

The speech recognition system can be implemented in accordance with the related art implementations based on PLC logic software provided by the PLC vendor, from which terms are provided as the library for the speech recognition system. Such PLC logic software can function to provide mapping of text to specific code fragments. In this manner, the mobile device can be configured to take input for programmable logic controller code, in which speech is converted to text based on the PLC logic software and text is then converted to code.

In the example of the vision-based device configuration, the user takes a picture 204 of one or more apparatuses 205 to be configured from the camera of the mobile device. The mobile device 206 is configured to process the image of the one or more apparatuses and identify them using related art image recognition techniques in accordance with the desired implementation. The mobile device 206 can receive a user input to select one of the apparatuses for providing code, and then once the apparatus is selected, executable PLC code can be provided to the PLC 103.

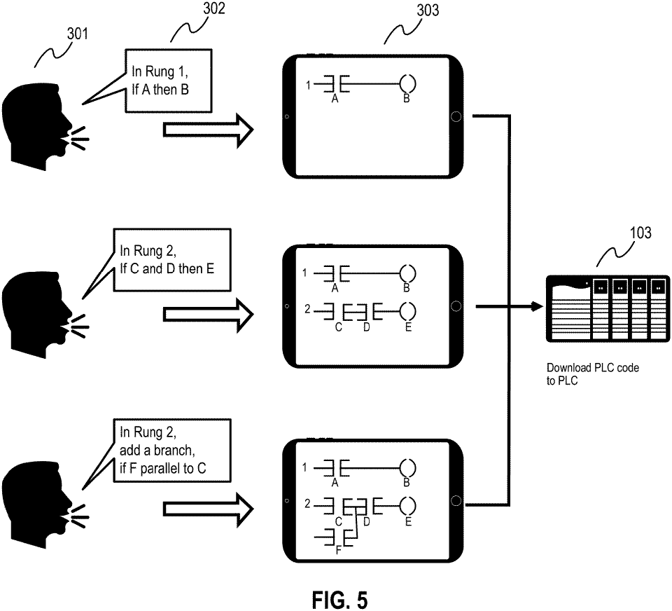

FIG. 5 is an example of speech-recognition-system-based PLC programming method, in accordance with an example implementation. The system generates the PLC ladder based on what the user says. The user 301 can add, edit, or delete any rung in the software by saying keywords 302 to the mobile device 303, and then download the final code to a PLC 103.

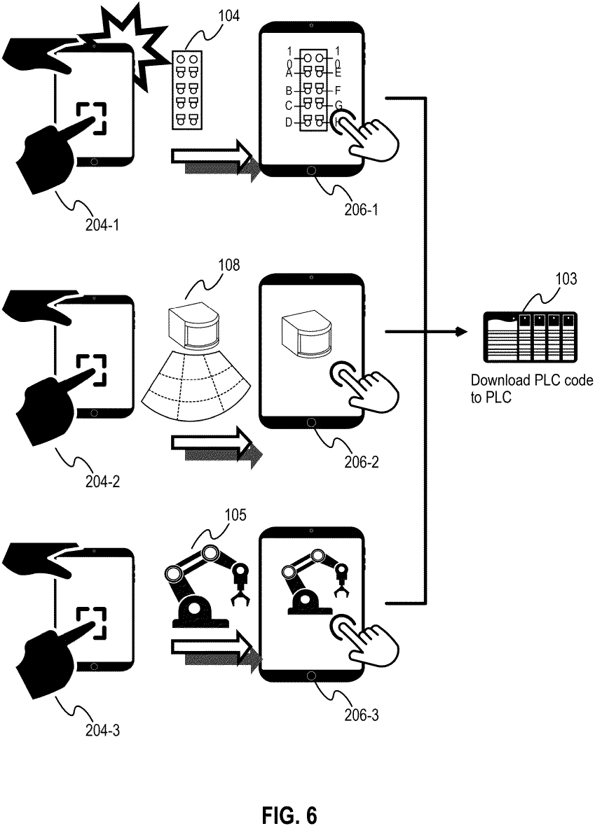

FIG. 6 is an illustration of three cases of the vision-based device configuration method, in accordance with an example implementation. In the first one, a user takes a picture 204-1 of an I/O adapter 104 and then the information is displayed on the mobile device 206-1 which can be edited by the user. The second case is the configuration of a safety scanner 108. After taking a photo 204-2, the user sets up a warning and alarm areas for the safety scanner through the mobile device 206-2. The last case is to configure an industrial robot 105. As with the other two cases, the information of that robot 105, such as I/O, communication, and 3D working area, which can be seen with the mobile device 206-3, can be set up with this mobile device at 204-3. Similar to the PLC ladder, after the configuration, the code will be downloaded to PLC. In addition, the above setup/configuration will involve variables that will can be made available in the PLC ladder for the users to conduct PLC programming.

Depending on the desired example implementation, the configuration information can be obtained from the Bluetooth connection. The Bluetooth connection can be selected based on timestamp in conjunction with the image, or in cases in which multiple apparatuses are found, then based on location information or sorted based on image recognition on the apparatuses. An interface can be provided from which the user can select one of the apparatuses and corresponding Bluetooth connection from the mobile device.

Input can then be received (e.g., via voice recognition, via touch screen implementation) to reconfigure the selected apparatus; and based on such a configuration, new new configuration information from the additional input and the retrieved configuration information through modification of the old configuration information. Accordingly, executable code can be provided to the PLC and the selected apparatus can be provided with new configuration information via the PLC.

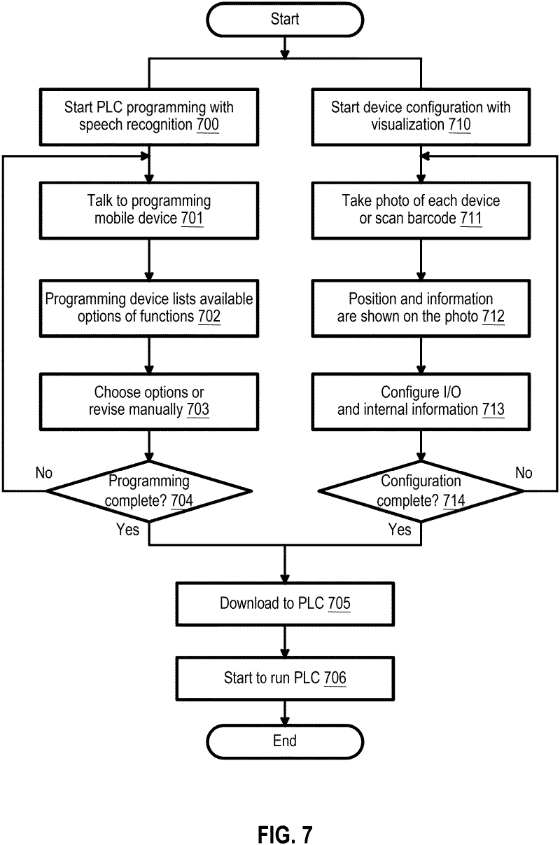

FIG. 7 is the workflow of the proposed methods, in accordance with an example implementation. On the left-hand side, the programming device generates and lists available functions for users to choose after listening to the user. Then PLC code will be downloaded to PLC once program is verified. On the right-hand side, the user takes a photo or scans a barcode of the device for configuration, and then the information can be edited on the mobile device. Once done, the configuration file can be downloaded to the PLC.

In the flow for conducting the PLC programming with speech recognition 700, at 701, the flow starts from the user talking to the programming mobile device as shown at 201 and 202 of FIG. 4. At 702, the programming device lists available options of functions as illustrated at 203 and 303 of FIG. 5. Once the options of functions are provided on the screen of the mobile device, the user can select the desired options or revise manually 703. At 704, a determination is made as to whether the programming is complete. If so (Yes), then the flow proceeds to 705, otherwise (No), the flow reverts to 701.

In the flow for starting the device configuration with a visualization 710, at 711, the flow starts when the user takes a photo image of each device and/or scans a barcode as shown at 204 of FIG. 4 or FIG. 6. In example implementations, the mobile device captures a picture image of the bar code attached to the apparatus in question with the camera, from which software as known in the art can extract the bar code information from the image and obtain the device information from the barcode information. In another example implementation, the mobile device can be configured to simply scan the bar code to obtain such information if desired. Further, the present disclosure is not limited to barcode, but can be replaced by other indicia such as quick response (QR) codes, augmented reality (AR) markers, embedded media markers, and so on in accordance with the desired implementation.

In another example implementation of extracting code information at 711, the image can be associated with a Bluetooth transmission from a Bluetooth device based on the timestamp of the image and the Bluetooth connection requests obtained from the mobile device. The Bluetooth connection can be used to retrieve the code information from the apparatus itself or the configuration information in accordance with the desired implementation.

At 712, the position and information are shown on the photo as illustrated at 206 of FIG. 4 and FIG. 6. At 713, the mobile device configures the I/O and internal information as shown at 205 and 206 of FIG. 4 and FIG. 6. At 714, a determination is made as to whether the configuration is complete. If so (yes) then the flow proceeds to 705 otherwise (No) the flow reverts to 711.

Once the configuration is made, at 705, the flow provides the transmission of executable to be executed by the PLC. The PLC can then execute the executable code at 706.

The simplified PLC programming method as described herein can be applied to most PLC and device vendors as long as they provide barcodes and information for developing this software. In addition, this method can be used in any production line, such as automotive, food, and oil & gas industries.

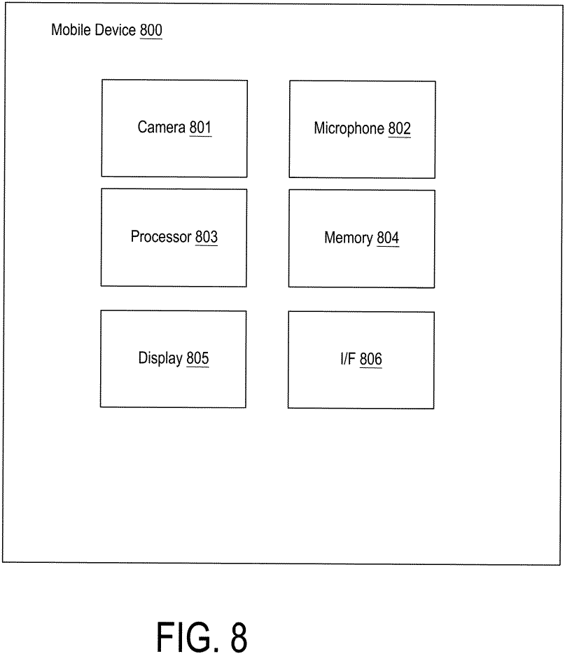

FIG. 8 illustrates an example of a mobile device, in accordance with an example implementation. The mobile device 800 can be any type of mobile device in accordance with the desired implementation, such as, but not limited to, cell phones, smart phones, tablets, laptops, and so on. Mobile device 800 can include camera 801, microphone 802, processor 803, memory 804, display 805, and interface (I/F) 806. Camera 801 can include any type of camera that is configured to record any form of video in accordance with the desired implementation. Microphone 802 can involve any form of microphone that is configured to record any form of audio in accordance with the desired implementation. Display 805 can involve a touch screen display configured to receive touch input to facilitate instructions to execute the functions as described herein, or a normal display such as a liquid crystal display (LCD) or any other display in accordance with the desired implementation. I/F 806 can include network interfaces to facilitate connections of the mobile device 800 to external elements such as the programmable logic controller (PLC) and any other device in accordance with the desired implementations, which may involve a connection over local area network (LAN) to connect to the PLC and factory or industrial apparatuses for security purposes. Processor 803 can be in the form of hardware processors such as central processing units (CPUs) or in a combination of hardware and software units in accordance with the desired implementation.

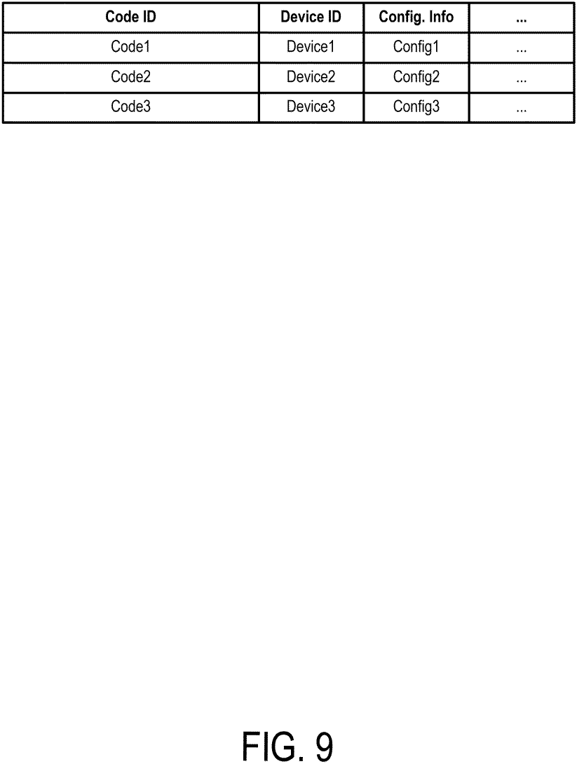

Memory 804 can be configured to manage a portion of all of management information as illustrated in FIG. 9, in accordance with the desired implementation.

In a first aspect, processor(s) 803 can be configured to execute a method or computer instructions involving receiving input from one or more of the camera and the microphone; generating one or more of executable code for the PLC and configuration information for the one or more apparatuses from parsing of the input; and transmitting, over the LAN, the one or more of the executable code for the PLC and the configuration information for the one or more apparatuses to the PLC as illustrated in FIG. 4 and from information as illustrated in FIG. 9.

In a second aspect, processor(s) 803 can be configured to execute the method or computer instructions in accordance with the first aspect, wherein executable code is generated from speech recognition of the input to the microphone, wherein the PLC executes the executable code once received as illustrated in FIG. 4, FIG. 5, FIG. 7, and FIG. 9.

In a third aspect, processor(s) 803 can be configured to execute the method or computer instructions in accordance with any of the above aspects, wherein generating the configuration information involves parsing an image from the camera to select an apparatus from the one or more apparatuses; retrieving the configuration information for the selected apparatus; receiving additional input to reconfigure the selected apparatus; and generating new configuration information from the additional input and the retrieved configuration information; wherein the selected apparatus is reconfigured from new configuration information as illustrated in FIG. 4, FIG. 6, and FIG. 7, and FIG. 9.

In a fourth aspect, processor(s) 803 can be configured to execute the method or computer instructions in accordance with any of the above aspects, wherein the image involves a barcode, and wherein the selection is conducted on the apparatus associated with the barcode as illustrated in FIG. 7 and FIG. 9.

In a fifth aspect, processor(s) 803 can be configured to execute the method or computer instructions in accordance with any of the above aspects, wherein the selection is based on a Bluetooth device transmitting an identifier to the mobile device as described in FIG. 7 and FIG. 9.

FIG. 9 illustrates example management information which may be stored on the mobile device to facilitate the example implementations described herein. Management information can include a code identifier corresponding to information extracted from the bar code, from a Bluetooth connection, or other code in accordance with the desired implementation, the device identifier that corresponds to the code (e.g., PLC, apparatus, etc.), and configuration information of the device. Configuration information can involve configuration information as provided by the apparatus. The management information of FIG. 9 can be provided by the PLC over LAN, and/or can be managed either by memory 804 or by PLC depending on the desired implementation.

Some portions of the detailed description are presented in terms of algorithms and symbolic representations of operations within a computer. These algorithmic descriptions and symbolic representations are the means used by those skilled in the data processing arts to convey the essence of their innovations to others skilled in the art. An algorithm is a series of defined steps leading to a desired end state or result. In example implementations, the steps carried out require physical manipulations of tangible quantities for achieving a tangible result.

Unless specifically stated otherwise, as apparent from the discussion, it is appreciated that throughout the description, discussions utilizing terms such as “processing,” “computing,” “calculating,” “determining,” “displaying,” or the like, can include the actions and processes of a computer system or other information processing device that manipulates and transforms data represented as physical (electronic) quantities within the computer system’s registers and memories into other data similarly represented as physical quantities within the computer system’s memories or registers or other information storage, transmission or display devices.

Example implementations may also relate to an apparatus for performing the operations herein. This apparatus may be specially constructed for the required purposes, or it may include one or more general-purpose computers selectively activated or reconfigured by one or more computer programs. Such computer programs may be stored in a computer readable medium, such as a computer-readable storage medium or a computer-readable signal medium. A computer-readable storage medium may involve tangible mediums such as, but not limited to optical disks, magnetic disks, read-only memories, random access memories, solid state devices and drives, or any other types of tangible or non-transitory media suitable for storing electronic information. A computer readable signal medium may include mediums such as carrier waves. The algorithms and displays presented herein are not inherently related to any particular computer or other apparatus. Computer programs can involve pure software implementations that involve instructions that perform the operations of the desired implementation.

Various general-purpose systems may be used with programs and modules in accordance with the examples herein, or it may prove convenient to construct a more specialized apparatus to perform desired method steps. In addition, the example implementations are not described with reference to any particular programming language. It will be appreciated that a variety of programming languages may be used to implement the techniques of the example implementations as described herein. The instructions of the programming language(s) may be executed by one or more processing devices, e.g., central processing units (CPUs), processors, or controllers.

As is known in the art, the operations described above can be performed by hardware, software, or some combination of software and hardware. Various aspects of the example implementations may be implemented using circuits and logic devices (hardware), while other aspects may be implemented using instructions stored on a machine-readable medium (software), which if executed by a processor, would cause the processor to perform a method to carry out implementations of the present application. Further, some example implementations of the present application may be performed solely in hardware, whereas other example implementations may be performed solely in software. Moreover, the various functions described can be performed in a single unit, or can be spread across a number of components in any number of ways. When performed by software, the methods may be executed by a processor, such as a general purpose computer, based on instructions stored on a computer-readable medium. If desired, the instructions can be stored on the medium in a compressed and/or encrypted format.

Moreover, other implementations of the present application will be apparent to those skilled in the art from consideration of the specification and practice of the techniques of the present application. Various aspects and/or components of the described example implementations may be used singly or in any combination. It is intended that the specification and example implementations be considered as examples only, with the true scope and spirit of the present application being indicated by the following claims

What is claimed is:

1. A method for a mobile device connected to a local area network (LAN) facilitating connections between a programmable logic controller (PLC) and one or more apparatuses, the mobile device comprising a camera and a microphone, the method comprising:
receiving input from one or more of the camera and the microphone;
generating one or more of executable code for the PLC and configuration information for the one or more apparatuses from parsing of the input; and
transmitting, over the LAN, the one or more of the executable code for the PLC and the configuration information for the one or more apparatuses to the P LC.

2. The method of claim 1, wherein the executable code is generated from speech recognition of the input to the microphone, wherein the PLC executes the executable code once received.

3. The method of claim 1, wherein generating the configuration information comprises:
parsing an image from the camera to select an apparatus from the one or more apparatuses;
retrieving the configuration information for the selected apparatus;
receiving additional input to reconfigure the selected apparatus; and
generating new configuration information from the additional input and the retrieved configuration information;
wherein the selected apparatus is reconfigured from the new configuration information.

4. The method of claim 3, wherein the image comprises a barcode, and wherein the selection is conducted on the apparatus associated with the barcode.

5. The method of claim 3, wherein the selection is based on a Bluetooth device transmitting an identifier to the mobile device.

6. A non-transitory computer readable medium, storing instructions for a mobile device connected to a local area network (LAN) facilitating connections between a programmable logic controller (PLC) and one or more apparatuses, the mobile device comprising a camera and a microphone, the instructions comprising:
receiving input from one or more of the camera and the microphone;
generating one or more of executable code for the PLC and configuration information for the one or more apparatuses from parsing of the input; and
transmitting, over the LAN, the one or more of the executable code for the PLC and the configuration information for the one or more apparatuses to the PLC.

7. The non-transitory computer readable medium of claim 6, wherein the executable code is generated from speech recognition of the input to the microphone, wherein the PLC executes the executable code once received.

8. The non-transitory computer readable medium of claim 6, wherein generating the configuration information comprises:
parsing an image from the camera to select an apparatus from the one or more apparatuses;
retrieving the configuration information for the selected apparatus;
receiving additional input to reconfigure the selected apparatus; and
generating new configuration information from the additional input and the retrieved configuration information;
wherein the selected apparatus is reconfigured from the new configuration information.

9. The non-transitory computer readable medium of claim 8, wherein the image comprises a barcode, and wherein the selection is conducted on the apparatus associated with the barcode.

10. The non-transitory computer readable medium of claim 8, wherein the selection is based on a Bluetooth device transmitting an identifier to the mobile device.

11. A mobile device configured to be connected to a local area network (LAN) facilitating connections between a programmable logic controller (PLC) and one or more apparatuses, the mobile device comprising:
a camera;
a microphone; and
a processor, configured to:
receive input from one or more of the camera and the microphone;
generate one or more of executable code for the PLC and configuration information for the one or more apparatuses from parsing of the input; and
transmit, over the LAN, the one or more of the executable code for the PLC and the configuration information for the one or more apparatuses to the PLC.

12. The mobile device of claim 11, wherein the executable code is generated from speech recognition of the input to the microphone, wherein the PLC executes the executable code once received.

13. The mobile device of claim 11, wherein the processor is configured to generate the configuration information by:
parsing an image from the camera to select an apparatus from the one or more apparatuses;
retrieving the configuration information for the selected apparatus;
receiving additional input to reconfigure the selected apparatus; and
generating new configuration information from the additional input and the retrieved configuration information;
wherein the selected apparatus is reconfigured from the new configuration information.

14. The mobile device of claim 13, wherein the image comprises a barcode, and wherein the selection is conducted on the apparatus associated with the barcode.

15. The mobile device of claim 13, wherein the selection is based on a Bluetooth device transmitting an identifier to the mobile device.
